(19) United States
(12) Patent Application Publication
(10) Pub. No.: US 2005/0130023 A1
(43) Pub. Date: Jun. 16, 2005

(54) Gas diffusion layer having carbon particle mixture

(76) Inventors: Jeffrey I. Lebowitz, Drexel Hill, PA (US); Mark R. Kinkelaar, Glenmoore, PA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/837,890

(22) Filed: May 4, 2004

Related U.S. Application Data
(60) Provisional application No. 60/469,022, filed on May 9, 2003.

(51) Int. Cl. H01M 4/86; H01M 4/90; H01M 4/96; H01M 8/10; H01M 2/14

(52) U.S. Cl. 429/41; 429/30; 429/33; 429/40; 429/44; 429/38; 429/39

(57) ABSTRACT

The invention relates to a gas diffusion layer, a device having the gas diffusion layer and a catalyst layer, a fuel cell containing the gas diffusion layer, and a gas diffusion electrode. The gas diffusion layer comprises a flexible, electrically non-conductive, porous material having a solid matrix, interconnected pores or interstices through the solid matrix, at least one external surface and internal surfaces, which internal surfaces are the surfaces of the walls of the pores or interstices, wherein at least a portion of the at least one external surface is coated with one or more layers of an electrically conductive material, the electrically conductive material comprising a mixture of at least two populations of electrically conductive carbon particles of different size, wherein the at least two populations of electrically conductive carbon particles are substantially uniformly mixed in the direction of a plane extending along the at least one external surface.

### CROSS REFERENCE TO RELATED APPLICATION

The instant application claims the benefit of U.S. Provisional Patent Application No. 60/469,022 filed on May 9, 2003, the disclosure of which is herein incorporated by reference.

### FIELD OF THE INVENTION

This invention relates to a flexible, electrically non-conductive, porous media coated with at least two populations of electrically conductive carbon particles of different size useful as a gas diffusion layer suitable to be placed adjacent to a cathode to help deliver oxygen to a cathode and/or a gas diffusion layer suitable to be placed adjacent to an anode to help deliver hydrogen to an anode in polymer electrolyte or proton exchange membrane (PEM) fuel cells. The coated porous media is also useful as a gas diffusion electrode (GDE) or a substrate for other electrochemical devices.

### BACKGROUND OF THE INVENTION

In PEM fuel cells, positive ions within the membrane are mobile and free to carry positive charge through the membrane. Movement of hydrogen ions (protons) through the membrane from the anode to the cathode is essential to PEM fuel cell operation. The hydrogen ions pass through the membrane and combine with oxygen and electrons on the cathode side producing water. Electrons cannot pass through the membrane. Therefore, electrons collected at the anode flow through an external circuit driving an electric load that consumes the power generated by the cell and are distributed to the cathode. The product of the reaction at the cathode is water. The open circuit voltage from a single cell is about 1 to 1.2 volts. Several PEM fuel cells can be stacked in series to obtain greater voltage and membrane area can be increased to get more amperage

In PEM fuel cells, an oxidation half-reaction occurs at the anode, and a reduction half-reaction occurs at the cathode. In the oxidation half-reaction, gaseous hydrogen produces hydrogen ions and electrons, wherein the hydrogen ions travel through the proton conducting membrane to the cathode and the electrons travel through an external circuit to the cathode. In the reduction half-reaction, oxygen supplied from air flowing past the cathode combines with the hydrogen ions and electrons to form water and excess heat. Catalysts, e.g. a noble metal such as platinum in particulate form, are used on both the anode and cathode to increase the rates of each half-reaction. The final products of the overall cell reaction are electric power, water and heat. The fuel cell is cooled, usually to about 80° C. At this temperature, the water produced at the cathode is in both a liquid form and vapor form. The water in the vapor form is carried out of the fuel cell by air flow through a gas diffusion layer and flow fields or channels in a bipolar plate.

A typical PEM fuel cell structure 1 in the prior art is shown in FIG. 1 in exploded view. The membrane electrode assembly (“MEA”) 4 is comprised of a PEM 6 with an anode layer 5 adjacent one surface and a cathode layer 5A adjacent an opposite surface. Gas diffusion layers 3, 3A are positioned adjacent each electrode layer. Bipolar plates 2, 2A are positioned adjacent each gas diffusion layer 3, 3A. The bipolar plates generally are fabricated of a conductive material and have channels (or flow fields) 7 through which reactants and reaction by-products may flow. The adjacent layers of the fuel cell structure contact one another, but in FIG. 1 are shown separated from one another in exploded view for ease of understanding and explanation.

The polymer electrolyte or proton exchange membrane (PEM) is a solid, organic polymer, usually polyperfluorosulfonic acid, that comprises the inner core of the membrane electrode assembly (MEA). Commercially available polyperfluorosulfonic acids for use as PEMs are sold by E.I. DuPont de Nemours & Company under the trademark NAFION®). Alternative PEM structures are composites of porous polymeric membranes impregnated with perfluoro ion exchange polymers, such as offered by W.L. Gore & Associates, Inc.

A substantial amount of water is liberated at the cathode and must be removed so as to prevent flooding the cathode or blocking the gas flow channels in the bipolar plate, cutting off the oxygen supply and locally halting the reaction. In prior art fuel cells, air is flown past the cathode to carry all the water present at the cathode as vapor out of the fuel cell.

Prior art fuel cells incorporated porous carbon papers, carbon fiber papers or carbon cloths as gas diffusion layers or backing layers adjacent to the PEM of the MEA. The porous carbon materials not only helped to diffuse reactant gases to the electrode catalyst sites, but also assisted in water management. Porous carbon paper was selected because carbon conducts the electrons exiting the anode and entering the cathode. However, porous carbon paper has not been found to be an effective material for directing excess water away from the cathode, and often a hydrophobic layer is added to the carbon paper to help with water removal. The carbon papers have limited flexibility, and tend to fail catastrophically when bent or dropped. Such carbon papers cannot be supplied in a roll form, and, therefore, are less amenable to automated fabrication and assembly. They tend to be rigid and non-conforming, and are not compressible. Careful tolerances are required to maintain an intimate electrical contact between the MEA and the bipolar plate via the carbon paper. And porous carbon papers are expensive. Consequently, the fuel cell industry continues to seek gas diffusion layers that will improve fuel delivery and by-product recovery and removal, maintain effective gas diffusion and effective conductive contact, and simplify the manufacturing of fuel cells without adversely impacting fuel cell performance or adding significant weight or expense.

Consequently, the fuel cell industry continues to seek improved gas diffusion layers that will maintain effective gas diffusion and maintain effective current conductivity without adversely impacting fuel cell performance or adding significant thickness, weight or expense. The present invention is aimed at solving some of the problems associated with prior art gas diffusion layers by providing improved gas diffusion layers.

### SUMMARY OF THE INVENTION

According to a first aspect of the invention, a gas diffusion layer for a fuel cell comprises a flexible, electrically non-conductive, porous material having a solid matrix and interconnected pores or interstices therethrough that has at least one external surface and internal surfaces, which “internal surfaces” are the surfaces of the walls of the pores or interstices, wherein at least a portion, or preferably substantially all, of the at least one external surface is coated with one or more layers of an electrically conductive material. The electrically conductive material comprises a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1:m, with m being at least 500, preferably at least 1000, more preferably at least 1500, further more preferably at least 2000, even more preferably at least 2500, and much more preferably at least 3000;
(b) at least population C of electrically conductive non-fibrous carbon particles and population D of electrically conductive carbon fibers, wherein the ratio of the D50% of population C and the average length of the fibers of population D is 1:n, with n being at least 2, preferably at least 5, more preferably at least 10, further more preferably at least 100, even more preferably at least 1000, and much more preferably at least 2000; and
(c) at least population E of electrically conductive carbon fibers and population F of electrically conductive carbon fibers, wherein the ratio of the average length of the fibers of population E and the average length of the fibers of population F is 1:p, with p being at least 2, preferably at least 5, more preferably at least 10, even more preferably at least 20, much more preferably at least 50 and even much more preferably at least 100.

The value of m can range from about 500 or about 1000 to about 9000, preferably about 1500 to about 8000, more preferably about 2000 to about 7000, further more preferably about 2500 to about 6000, even more preferably about 2500 to about 5000, much more preferably about 2500 to about 4000, and further much more preferably about 3000 to about 4000. The value of n can range from about 2 to about 5000, preferably about 5 to about 3000, more preferably about 10 to about 2000, even more preferably about 50 to about 1500, and much more preferably about 100 to about 1000. The value of p can range from about 2 to about 2000, preferably about 5 to about 1500, more preferably about 10 to about 1000, and even more preferably about 20 to about 800, or about 50 to about 500.

In the electrically conductive material comprising a mixture of at least two populations of electrically conductive carbon particles, the content of the smallest population can range from about 1% to about 50%, preferably about 2.5% to about 40%, more preferably about 5% to about 30%, further more preferably about 7.5% to about 20%, even more preferably about 10% to about 20%, and much more preferably about 10% to about 15%, based on the dry weight of all the electrically conductive carbon particles in the mixture.

The at least one external surface being coated, partially or substantially entirely, with the electrically conductive material is especially suitable to be the external surface in contact with an electrode when the gas diffusion layer is installed in a fuel cell.

In some of the embodiments of the gas diffusion layer of the invention, in addition to the at least one external surface being coated with the electrically conductive material, at least portions, or preferably substantially all, of the internal surfaces of the flexible, electrically non-conductive, porous material are coated with one or more layers of the electrically conductive material, with the coated internal surfaces and the coated at least one external surface together forming an electrically conductive pathway.

In some of the embodiments of the gas diffusion layer of the invention, wherein the flexible, electrically non-conductive, porous material has two or more external surfaces, in addition to at least a portion of the at least one external surface being coated with the electrically conductive material, at least a portion, or preferably substantially all, of at least another external surface of the flexible, electrically non-conductive, porous material is coated with one or more layers of the electrically conductive material, with the coated at least one external surface and the coated at least another external surface being contiguous so that the coated at least one external surface and the coated at least another external surface form an electrically conductive pathway. Optionally, at least portions, or preferably substantially all, of the internal surfaces of the flexible, electrically non-conductive, porous material are coated with one or more layers of the electrically conductive material, with the coated internal surfaces, the coated at least one external surface and the coated at least another external surface together forming an electrically conductive pathway.

In some of the embodiments of the gas diffusion layer of the invention, wherein the flexible, electrically non-conductive, porous material has two or more external surfaces, in addition to at least a portion of the at least one external surface being coated with the electrically conductive material, at least a portion, or preferably substantially all, of another external surface of the flexible, electrically non-conductive, porous material is coated with one or more layers of the electrically conductive material, with the coated at least one external surface being opposite to the coated another external surface. Furthermore, at least portions, or preferably substantially all, of the internal surfaces of the flexible, electrically non-conductive, porous material are coated with one or more layers of the electrically conductive material, with the coated internal surfaces, the coated at least one external surface and the coated another external surface together forming an electrically conductive pathway.

The flexible, electrically non-conductive, porous material for the gas diffusion layer of the invention can be polymeric. The flexible, electrically non-conductive, porous polymeric material can be selected from foams, bundled fibers, matted fibers, needled fibers, woven or nonwoven fibers, porous polymers made by pressing polymer beads, Porex and Porex like polymers. The flexible, electrically non-conductive, porous polymeric material preferably is selected from foams, bundled fibers, matted fibers, needled fibers, and woven or nonwoven fibers. More preferably, the flexible, electrically non-conductive, porous polymeric material is selected from polyurethane foams (preferably felted polyurethane foams, reticulated polyurethane foams, or felted reticulated polyurethane foams), melamine foams, polyvinyl alcohol foams, or nonwoven felts, woven fibers or bundles of fibers made of polyamide such as nylon, polyethylene, polypropylene, polyester such as polyethylene terephthalate, cellulose, modified cellulose such as Rayon, polyacrylonitrile, and mixtures thereof. The flexible, electrically non-conductive, porous polymeric material is, further more preferably, a foam such as a polyurethane foam, e.g. felted polyurethane foam, reticulated polyurethane foam, or felted reticulated polyurethane foam. Even more preferably, the flexible, electrically non-conductive, porous polymeric material is a flexible reticulated polymer foam such as a flexible reticulated polyurethane foam.

A flexible reticulated foam can be produced by removing the cell windows from a flexible cellular polymer structure, leaving a network of strands and thereby increasing the fluid permeability of the resulting reticulated foam. Foams may be reticulated by in situ, chemical or thermal methods known to those of skill in foam production.

If a foam is used to form the gas diffusion layer of the invention, the foam can be a polyether polyurethane foam having a pore size in the range of about 3 to about 300 pores per linear inch, and a density in the range of about 0.5 to about 10.0 pounds per cubic foot prior to coating.

The flexible, electrically non-conductive, porous material can be of any physical shape as long as it has at least one flat surface for making contact with one of the electrodes when the gas diffusion layer is installed in a fuel cell. Thus, when a foam, such as a flexible reticulated polyurethane foam, is used as the flexible, electrically non-conductive, porous material, the foam can be of any physical shape when not compressed as long as the foam has at least one flat surface in a uncompressed state (e.g. a foam in the shape of a sheet) or compressed state (e.g. a foam in the shape of a cylinder, or the shape of a structure having a curved external surface in contiguous with two end external surfaces and an oval transverse cross section) for making contact with an electrode when installed in a fuel cell.

In some of the embodiments of the gas diffusion layer of the invention, if the flexible, electrically non-conductive, porous material is a flexible reticulated polymer foam comprising a network of strands forming interstices therebetween, at least a portion of the network of such strands of at least one external surface of the porous material is coated with one or more layers of the electrically conductive material. Preferably, at least a portion of the network of such strands on the at least one external surface and at least a portion of the network of such strands inside the foam are coated with one or more layers of the electrically conductive material. Preferably, at least some of the strands on the at least one external surface of the foam that will be disposed adjacent to an electrode when installed in a fuel cell are coated with one or more layers of the electrically conductive material. More preferably, in addition to at least some of the strands on the surface of the foam that will be disposed adjacent to the electrode being coated with the electrically conductive material, at least some of the strands inside the foam are coated with one or more layers of the electrically conductive material. Even more preferably, (i) at least some of the strands on the at least one external surface that will be disposed adjacent to the electrode, (ii) at least some of the internal strands of the foam, and (iii) at least some of the strands of an external surface of the foam that will be disposed adjacent to a separator or bipolar plate when the gas diffusion layer is installed in the fuel cell are coated with one or more layers of the electrically conductive material to create an electrically conductive path from the electrode to the separator or bipolar plate.

In this patent application, the term “electrically conductive non-fibrous carbon particles” refers to electrically conductive particles that are not in the form of fibers. Exemplary electrically conductive non-fibrous carbon particles include amorphous carbon particles, such as carbon black powder and amorphous graphite powder, and non-fibrous graphite particles, such as graphite flakes. The graphite can be naturally occurring graphite or synthetic graphite.

As used herein, “fibers” are defined as thin, threadlike solid particles. Preferably, the “electrically conductive carbon fibers” have an average length at least 5 times an average diameter, i.e. an aspect ratio of at least 5. More preferably, the average length is at least 10, even more preferably at least 20, times the average diameter. For instance, the average length of the “electrically conductive carbon fibers” can be about 5 to about 100 times, more preferably about 10 to about 50 times, even more preferably about 10 to about 30 times, the average diameter. The electrically conductive carbon fibers can be made from polyacrylonitrile or pitch. An example of carbon fibers that can be used has a size of about 7 μm×200 μm.

Some of the examples of the electrically conductive carbon particles that can be used in the electrically conductive material for making the gas diffusion layer of the invention are commercially available. These examples include a carbon black powder having primary particles with D50% of about 0.03 pm commercially available as XC-72, which can be used as the smallest population, e.g. population A or C, of electrically conductive carbon particles in the electrically conductive material; AQUADAG E (AE) from Acheson Colloids, which contains colloidal graphite particles having a volume median diameter of about 0.9 μm; PB, which is a dispersion of carbon black powder having D50% of 0.446 μm and D90% of 0.960 μm commercially available from Solution Dispersions Inc.; Aldrich 150, which are graphite flakes having D90% of about 150 μm; A4957, which is a form of graphitized coke having D90% of about 40 μm; A4956, which is a form of graphitized coke having D90% of about 75 μm; 3160, which is a commercially available flake having D50% of about 114 μm and D90% of about 242 μm; size-selected 3160 having D50% of about 91 μm and D90% of about 140 μm; A3459, which is a form of carbon flakes having D50% of about 241 μm and D90% of about 400 μm; T-150 having D90% of about 180 μm available from Timcal; PGPO9 having D50% of about 10.5 pm and D90% of about 25 μm available from Morgan Specialty; SFG-75 having D50% of about 30.1 μm and D90% of about 60 μm available from Timcal; AGM99, which are carbon fibers with a size of 7 μm×150 μm; and AGM95, which are carbon fibers having a size of 13 μm×200 μm. The sizes of some of the electrically conductive non-fibrous carbon particles that can be used to coat the flexible, electrically non-conductive, porous material are shown in Table 1.

TABLE 1
Examples of Electrically Conductive Non-Fibrous Carbon Particles

| Particles | D50% (μm) | D90% (μm) |
|---|---|---|
| PB | 0.446 | 0.960 |
| A4957 | —* | 40 |
| A4956 | —** | 75 |
| 3160 | 114 | 242 |
| Size-Selected 3160 | 91 | 140 |
| A3459 | 241 | 400 |
| SGF-75 | 30.1 | 60 |
| PGP09 | 10.5 | 25 |

*D50% not measured; sieve analysis: 70 mesh, 0.00% retained, 80 mesh, 0.01% retained, 100 mesh, 0.01% retained, 200 mesh, 1.12% retained, and 325 mesh, 18.77% retained.
**D50% not measured; sieve analysis: 60 mesh, 0.00% retained, 80 mesh, 0.05% retained, 100 mesh, 1.20% retained, 140 mesh, 44.60% retained, 170 mesh, 26.70% retained, 200 mesh, 13.10% retained, and 325 mesh, 13.70% retained.

The term D90% is related to the particle size distribution and is the particle size at which 90%, by number, of the particles are no larger than. As an example, a population of graphite flakes having a D90% of 300 μm means that 90%, by number, of the graphite flakes in the population are 300 μm in size or smaller. The term D50% is defined as the size at which 50%, by number, of the particles are no larger than.

It is preferred that populations of electrically conductive carbon particles of similar density be used in the electrically conductive material for making the gas diffusion layer of the invention in order to form a homogeneous film when coated on a flexible, electrically non-conductive, porous material, and in order to increase the shelf-life of a liquid formulation containing a dispersion of the electrically conductive carbon particles. The densities of several electrically conductive powders are shown in Table 2.

TABLE 2
Density Values for Different Powders

| Powder | Density (g/cm³) |
|---|---|
| AE/PB Solids* | 0.159-0.24 |
| Aldrich 150 | 0.6362 |
| A4957 | 0.5964 |
| T-150 | 0.4275 |
| PGP09 | 0.3579 |
| SFG-75 | 0.3380 |
| AGM99 | 0.5964 |

*AE/PB solids are the solids of a dispersion containing a mixture of 10 wt % PB and 90 wt % AE, wherein the wt % is based on the total solid weight of the mixture.

In this application, the term “coated” means directly, intimately adhered to. When a portion of a surface of the flexible, electrically non-conductive, porous material is “coated” with an electrically conductive material, the electrically conductive material is intimately adhered to the portion of the surface leaving substantially no gap between the solid matrix of the “coated” portion and the electrically conductive material. Therefore, when the surface of a flexible, electrically non-conductive, porous material is “coated” with an electrically conductive material to make a gas diffusion layer according to the present invention, a flexible, electrically non-conductive, porous material having a carbon paper crimped onto the surface of the porous material is excluded. When a segment of a strand of the solid matrix of a flexible, electrically non-conductive, porous material forming a gas diffusion layer of the present invention is “coated” with an electrically conductive material, substantially the entire external surface of the segment has the electrically conductive material intimately adhered thereto so that a cross-sectional view of the segment shows a core of the solid matrix surrounded by and directly in contact with a layer of the electrically conductive material (e.g. see FIG. 3).

A surface of the flexible, electrically non-conductive, porous material may be coated with the electrically conductive material using a process known in the art, such as a dip and nip coating process or by painting the surface with a paint or slurry formed from a mixture of at least two populations of electrically conductive carbon particles dispersed in a liquid binder. If a polyurethane foam is used as the porous material, the coated polyurethane foam retains resiliency, recoverability and flexibility. Sheets of such coated polyurethane foam can be looped onto a roll for ease of transport and dispensing.

In the gas diffusion layer of the present invention, the one or more layers of the electrically conductive material coating the portion(s) of the surface(s) of the porous material can have a total thickness of no more than about 1000, 500, 100, 50, 10, 5, 1 or 0.1 micron, or a total thickness of about 0.1-1000, 1-1000, 1-500, 5-100 or 10-50 microns.

The flexible, electrically non-conductive, porous material forming the gas diffusion layer according to the present invention is preferably a foam, more preferably a polyether polyurethane foam, having a pore size in the range of about 3 to about 300 pores per linear inch, and a density in the range of about 0.5 to about 10.0 pounds per cubic foot before being coated with the at least one electrically conductive material.

In some of the embodiments of the gas diffusion layer of the invention, the flexible, electrically non-conductive, porous material is a foam. Before being coated with the electrically conductive material, the foam may be felted to adjust its surface area and permeability by compressing the foam under heat and pressure to a desired thickness and compression ratio, which permanently deforms the foam. Compression ratios of about 1 to about 20, e.g. 3, 4, 5 or 6, are preferred. For instance, for a compression ratio of 10, the foam is compressed to 1/10 of its original thickness.

Felting is carried out under applied heat and pressure to compress a foam structure to an increased firmness and reduced void volume. Once felted, the foam will not recover to its original thickness, but will remain compressed to a reduced thickness. Felted foams generally have improved capillarity and water holding than unfelted foams. Yet, felted foams still retain sufficient porosity to transmit gases therethrough. If a felted polyurethane foam (e.g. a felted flexible reticulated polyether polyurethane foam) is selected as the porous material for the gas diffusion layer, such foam can have a density in the range of about 0.6 to about 40 pounds per cubic foot after felting, and a compression ratio in the range of about 1 to about 20 (e.g. 3, 4, 5 or 6).

A second aspect of the invention is directed to a device comprising a gas diffusion layer of the invention as described above in contact with an electrode, either a cathode or anode, for a fuel cell, wherein the electrode comprises particulate catalyst and an optional solid backing. The catalyst is for the oxidiation/reduction carried out in the fuel cell and can be one noble metal, e.g. platinum (preferred), palladium, silver and gold, or a mixture of noble metals. In the device, the at least one external surface of the flexible, electrically non-conductive, porous material of the gas diffusion layer having at least a portion coated with the electrically conductive material is adjacent in contact with the electrode. Within the scope of the second aspect of the invention is a method of making the device, comprising the step of placing a gas diffusion layer of the invention in contact with an electrode suitable for use in a fuel cell.

A third aspect of the invention is directed to a fuel cell having at least one gas diffusion layer of the invention installed. The fuel cell of the invention can comprise the following layers in serial contact:
(i) a first separator or bipolar plate;
(ii) a first gas diffusion layer;
(iii) an anode, comprising a particulate catalyst, e.g. a particulate noble metal such as platinum, palladium, gold and silver, or mixtures thereof, on an optional solid support;
(iv) a solid polymer electrolyte or proton exchange membrane (PEM);
(v) a cathode, comprising a particulate catalyst, e.g. a particulate noble metal such as platinum, palladium, gold and silver, or mixtures thereof, on an optional solid support;
(vi) a second gas diffusion layer; and
(vii) a second separator or bipolar plate,
   wherein at least one, preferably both, of the first and second gas diffusion layers is a gas diffusion layer of the invention having the at least a portion, or preferably a substantial entirety, of the at least one external surface of the flexible, electrically non-conductive, porous material of the gas diffusion layer coated with the electrically conductive material being in contact with a surface of the anode or cathode opposite to an electrode surface in contact with the PEM, and wherein the at least one external surface of the flexible, electrically non-conductive, porous material is in an electrically conductive pathway with a separator or bipolar plate adjacent to the gas diffusion layer. When the first and second gas diffusion layers in a fuel cell of the invention are gas diffusion layers of the invention, the at least a portion, or preferably a substantial entirety, of the at least one external surface of the flexible, electrically non-conductive, porous material of the each of the first and second gas diffusion layers coated with the electrically conductive material is in contact with a surface of the respective electrode opposite to an electrode surface in contact with the PEM, and wherein the at least one external surface of the flexible, electrically non-conductive, porous material of each of the first and second gas diffusion layer is in an electrically conductive pathway with a separator or bipolar plate adjacent to the respective gas diffusion layer. The first and second gas diffusion layers may be the same or different, and preferably each comprises a sheet of foam such as polyether polyurethane foam, preferably reticulated, as the flexible, electrically non-conductive, porous material. The separator or bipolar plate can be a sheet of a substantially nonporous conductive material, such as a metal, carbon paper or carbon cloth. The bipolar plate can have flow fields, i.e. grooves, on at least one of its surface.

The gas diffusion layer of the invention disposed adjacent to the cathode has a longest dimension. Preferably, the flexible, electrically non-conductive, porous material, e.g. foam, in the cathode gas diffusion layer can wick water by capillary action and the water can subsequently be released from the porous material, wherein the porous material has a free rise wick height greater than at least one half of the longest dimension of the cathode gas diffusion layer. The porous material, more preferably, has a free rise wick height greater than at least the longest dimension of the cathode gas diffusion layer. The gas diffusion layer adjacent to the cathode can be in liquid communication with a liquid drawing means for drawing the water previously wicked into the cathode gas diffusion layer out of the fuel cell. The liquid drawing means is preferably a pump. The wicking action of the porous material, e.g. foam, in the gas diffusion layer adjacent to the cathode helps in removing water from the cathode to prevent flooding of the cathode.

The fourth aspect of the invention is directed to a gas diffusion electrode for a fuel cell, which gas diffusion electrode comprises a catalyst on at least an external surface of a solid substrate, wherein the catalyst is suitable for the oxidiation/reduction carried out in the fuel cell and can be a noble metal, e.g. platinum (preferred), palladium, silver and gold, or a mixture of noble metals, and the catalyst is preferably in the form of particulate, wherein the solid substrate comprises a flexible, electrically non-conductive, porous material having a solid matrix, interconnected pores or interstices through the solid matrix, at least one external surface and internal surfaces, which internal surfaces are the surfaces of the walls of the pores or interstices, wherein at least a portion of the at least one external surface is coated with one or more layers of an electrically conductive material,
the electrically conductive material comprising a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1 :m, with m being at least 500, preferably at least 1000;
(b) at least population C of electrically conductive non-fibrous carbon particles and population D of electrically conductive carbon fibers, wherein the ratio of the D50% of population C and the average length of the fibers of population D is 1:n, with n being at least 2, preferably at least 5; and
(c) at least population E of electrically conductive carbon fibers and population F of electrically conductive carbon fibers, wherein the ratio of the average length of the fibers of population E and the average length of the fibers of population F is 1:p, with p being at least 2, preferably at least 5; wherein the electrically conductive carbon particles, the flexible, electrically non-conductive, porous material and the values of m, n and p can be the same as those disclosed for the gas diffusion layer of the invention described above.

The fifth aspect of the invention is directed to a bipolar plate for a fuel cell, which bipolar plate comprises a flexible, electrically non-conductive, non-permeable material having a solid matrix and at least one external surface, wherein at least a portion of the at least one external surface is coated with one or more layers of an electrically conductive material,
the electrically conductive material comprising a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1:m, with m being at least 500, preferably at least 1000;
(b) at least population C of electrically conductive non-fibrous carbon particles and population D of electrically conductive carbon fibers, wherein the ratio of the D50% of population C and the average length of the fibers of population D is 1:n, with n being at least 2, preferably at least 5; and
(c) at least population E of electrically conductive carbon fibers and population F of electrically conductive carbon fibers, wherein the ratio of the average length of the fibers of population E and the average length of the fibers of population F is 1:p, with p being at least 2, preferably at least 5; wherein the values of m, n and p can be the same as those disclosed for the gas diffusion layer of the invention described above, and the non-permeable material can be a non-permeable polymeric material such as a felted polyurethane foam.

### BRIEF DESCRIPTION OF THE DRAWINGS

FIG. 1 is a schematic view in side elevation of a fuel cell according to the prior art that has two carbon fabric gas diffusion layers between the MEA and bipolar plates.

FIG. 2 is a schematic view in side elevation of a fuel cell according to the invention having two compressible coated foam gas diffusion layers of the invention between the MEA and the bipolar plates.

FIG. 3 is a schematic, perspective view of an embodiment of the gas diffusion layer of the invention.

FIG. 4 is a schematic, perspective view of another embodiment of the gas diffusion layer of the invention.

FIG. 5 is a schematic, perspective view of another embodiment of the gas diffusion layer of the invention.

FIG. 6 is a schematic, perspective view of another embodiment of the gas diffusion layer of the invention.

FIG. 7 is a schematic, perspective view of another embodiment of the gas diffusion layer of the invention.

FIG. 8 is a schematic, perspective view of another embodiment of the gas diffusion layer of the invention.

FIG. 9 is a schematic, perspective view of another embodiment of the gas diffusion layer of the invention.

FIG. 10 is a schematic, perspective view of another embodiment of the gas diffusion layer of the invention.

FIG. 11 is a schematic view in side elevation of a fuel cell according to the invention having two gas diffusion layers of the invention.

FIG. 12 is a schematic view in side elevation of another fuel cell according to the invention having two gas diffusion layers of the invention.

FIG. 13 is a schematic view in side elevation of another fuel cell according to the invention having two gas diffusion layers of the invention.

FIG. 14 is a schematic view in side elevation of another fuel cell according to the invention having two gas diffusion layers of the invention.

FIG. 15 is a schematic view in side elevation of another fuel cell according to the invention having two gas diffusion layers of the invention.

FIG. 16 is a schematic view in side elevation of another fuel cell according to the invention having two gas diffusion layers of the invention.

FIG. 17 shows the resistance of films prepared with various coating material, normalized to a dried film thickness (DFT) of 35 mils, wherein 1 mil is 0.001 inch and equivalent to 0.0254 mm.

FIG. 18 shows the effect of a non-fibrous, submicronic carbon black powder having D50% of about 0.03 μm (NSCP) in an electrically conductive material on film R.

FIG. 19 compares the resistance of films made with different electrically conductive materials.

FIG. 20 shows the surface resistivity of felted foams coated with various carbon particle formulations, versus percent pickup, created with an electrically conductive material, i.e. TC-146, a “Small PSD” material or a standard carbon coating.

FIG. 21 shows the volume resistivity, at various pressure loads, of four types of gas diffusion layer: a gas diffusion layer of the invention comprising a 2 mm thick 45 ppi, i.e. pores per inch, felt having an area of 25.8 cm² coated with TC-146; a 1.5 mm thick felt having 45 ppi and an area of 25.8 cm² coated with the “Small PSD” material; a 0.2 mm thick piece of Ballard's Avcarb carbon fiberpaper wet proofed with 30 wt % polytetrafluoroethylene; and a 0.8 mm thick piece of untreated Toray's carbon cloth.

FIG. 22 shows the resistance to a flow of nitrogen at 11 L/hour, of the four types of gas diffusion layer tested in FIG. 21.

FIG. 23 shows the compression behavior of the four types of gas diffusion layer tested in FIG. 21.

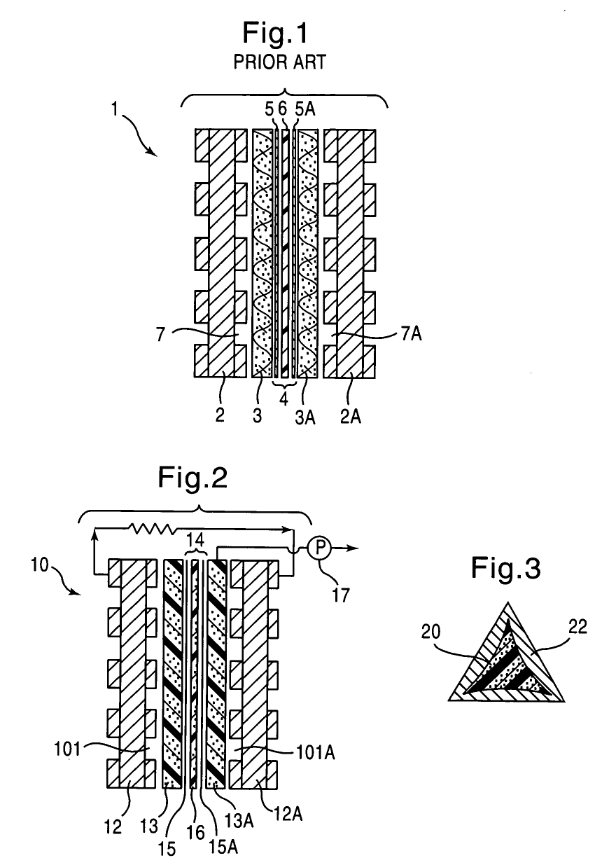

### DETAILED DESCRIPTION OF THE PREFERRED EMBODIMENTS

Referring first to FIG. 2, a fuel cell 10 includes a membrane electrode assembly (“MEA”) 14 comprising a polymer electrolyte membrane (“PEM”) 16 sandwiched between an anode 15 and a cathode 15A. The PEM 16 is a solid, organic polymer, usually a polyperfluorosulfonic acid, that comprises the inner core of the membrane electrode assembly (MEA). Catalyst layers (not shown) are present on each side of the PEM. The PEM must be hydrated to function properly as a proton (hydrogen ion) exchanger and as an electrolyte.

Adjacent to the anode 15 is provided a gas diffusion layer 13 formed from a 7 mm or less thick sheet of 85 pore per inch reticulated polyether polyurethane foam that is covered by a coat 22 of an electrically conductive material. See also FIG. 3. The gas diffusion layer 13 helps to distribute a source of hydrogen uniformly to the anode 15. It also collects electrons from the anode and provides a path for electron flow from the anode through a load 30 to the cathode 15A. Adjacent to each gas diffusion layer 13, 13A are bipolar plates 12, 12A.

Optionally, a separator (not shown) formed from an electrically conductive material compatible with the conductive material coating the gas diffusion layer may be provided adjacent to the gas diffusion layer along with or in place of each bipolar plate 12, 12A. Adjacent to the cathode 15A is provided a second gas diffusion layer 13A formed from a 7 mm or less thick sheet of 85 pore reticulated polyether polyurethane foam that has been coated with a conductive material. The second gas diffusion layer 13A helps to remove water from the cathode side of the fuel cell to prevent flooding, and allows air or other desired gaseous oxygen source to contact the cathode side to ensure oxygen continues to reach the active sites. The second gas diffusion layer 13A has a longest dimension. The second gas diffusion layer 13A preferably wicks the water from the cathode by capillary action, wherein the foam of the second gas diffusion layer has a free rise wick height greater than at least the longest dimension. Optionally, the second gas diffusion layer 13A is in liquid communication with a pump 17, which draws the water previously wicked into the second gas diffusion layer out of the second gas diffusion layer in order to move the water out of the fuel cell. The second gas diffusion layer 13A will transmit electrons completing the circuit between the anode and cathode.

In practice, each fuel cell component is position in contact with the adjacent components. FIG. 2 is presented in an exploded view and shows the components in spaced relation for ease of understanding.

In operation, a hydrogen source (gaseous such as hydrogen gas, or vapor such as methanol or water vapor) reacts at the surface of the anode 15 to liberate hydrogen ions and electrons. The hydrogen ions pass through the PEM 16 membrane and combine with oxygen and electrons on the cathode 15A side producing water. Electrons cannot pass through the membrane 16 and flow from the anode 15 to the cathode 15A through an external circuit containing an electric load 30 that consumes the power generated by the cell. The reaction product at the cathode is water. The PEM fuel cell operates at temperatures generally from 0° C. to 80° C., and the liberated water most often is in vapor form.

The gas diffusion layers 13, 13A according to the invention have a thickness in the range of 0.1 to 10 mm, preferably 7 mm or less, more preferably from 0.2 to 4.0 mm, and most preferably less than about 2.0 mm.

The gas diffusion layers 13, 13A are formed from flexible polyurethane foam, felted polyurethane foam, reticulated polyurethane foam, and felted reticulated polyurethane foam. A particularly preferred gas diffusion layer is formed from a flexible reticulated polyether polyurethane foam having a density in the range of 0.5 to 8.0 pounds per cubic foot and a pore size in the range of 3 to 300, preferably 5 to 150, pores per linear inch, more preferably greater than 70 pores per linear inch, e.g. about 85 pores per linear inch, before coating. Flexible polyurethane foams well suited for use as gas diffusion layers should rebound following compression and bend in a 3 inch loop without failing catastrophically (e.g. cracking, tearing, deforming, and taking a permanent set).

Referring to FIG. 3, the electrically conductive material 22 is coated onto the strands 20 of polyurethane foam to form a gas diffusion layer. The coating intimately surrounds each strut or strand in the cellular polyurethane network. Preferably the coating is a mixture of submicronic carbon black powder and electrically conductive large carbon particles, e.g. graphite flakes. The conductive coating may be applied using various methods known to those of skill in the art, including dipping in, spraying of or painting with a paint or slurry formed as a liquid medium, preferably aqueous, having at least two populations of electrically conductive carbon particles dispersed therein. In a dipping and nipping coating process, a foam can be first dipped in a coating liquid and then compressed in the nip formed between two compression platens or rollers to squeeze the coating liquid through the foam and cause excess coating liquid to be expelled from the foam.

A protective pre-coating of a non-conductive polymer may also be applied to the foam strands before the conductive coating is applied. Such pre-coatings may include acrylics, vinyls, natural or synthetic rubbers, or similar materials, and may be applied using a water borne or organic solvent borne coating process, such as dipping, or painting, optionally followed by nipping.

The electrically conductive coating applied to the strands of the polyurethane foam to form the gas diffusion layer should have a resistivity less than 20 ohm-cm, preferably less than 1 ohm-cm. The gas diffusion layer must be capable of collecting and conducting the current from the anode for use in a load and return to the cathode. In a fuel cell stack, the gas diffusion layer conducts the current from the anode of one fuel cell to the cathode of an adjacent fuel cell.

Significant advantages of the gas diffusion layers according to the invention are resilency, flexibility, and ease of handling. The gas diffusion layers readily conform to the space into which they are installed. The foams rebound after compression such that good contact may be maintained between the gas diffusion layer and the surface of the respective anode or cathode that is adjacent to the gas diffusion layer. Improved contact means greater efficiency in current transfer. Moreover, because the gas diffusion layers according to the invention can be made with flexible and compressible foams, they do not have the drawbacks associated with perforated or foamed metals, which can puncture the MEA and deform when handled during fuel cell assembly. The flexible and compressible gas diffusion layers of the present invention also have advantages over traditional carbon papers, which are fragile and only available in flat sheet form, making them less amenable to automated assembly.

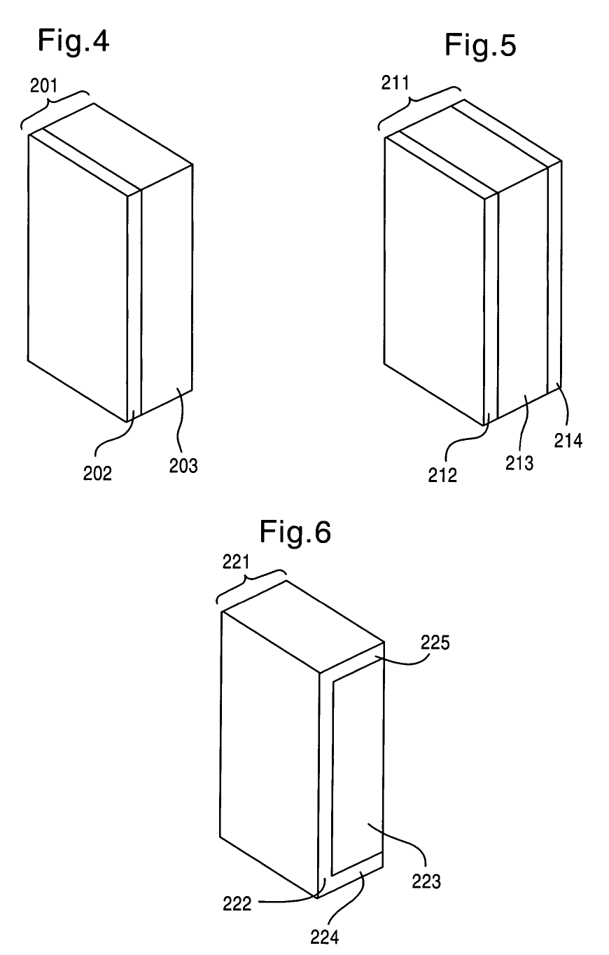

An embodiment of the gas diffusion layer 201 of the invention is shown in FIG. 4. The flexible, electrically non-conductive, porous material 203 has a rectangular shape having four side external surfaces and two end external surfaces, wherein substantially the entirety of one of the side external surfaces and at least portions of the internal surfaces are coated with one or more layers of an electrically conductive material 202 (the coating of the internal surfaces is not shown in FIG. 4), wherein the coated side external surface and the coated internal surfaces together form an electrically conductive pathway.

Another embodiment of the gas diffusion layer 211 of the invention is shown in FIG. 5. The flexible, electrically non-conductive, porous material 213 has a rectangular shape having four side external surfaces and two end external surfaces, wherein two opposite side external surfaces and at least portions of the internal surfaces are coated with one or more layers of the electrically conductive material 212, 214 (the coating of the internal surfaces is not shown), wherein the coated opposite side external surfaces and the coated internal surfaces together form an electrically conductive pathway.

In an alternative example of the gas diffusion layer 221 (shown in FIG. 6), the flexible, electrically non-conductive, porous material 223 has a rectangular shape having four side external surfaces and two end external surfaces, wherein one of the side external surfaces and both end external surfaces are coated with one or more layers of the electrically conductive material 222, 224, 225, wherein the internal surfaces may or may not be coated with the electrically conductive material.

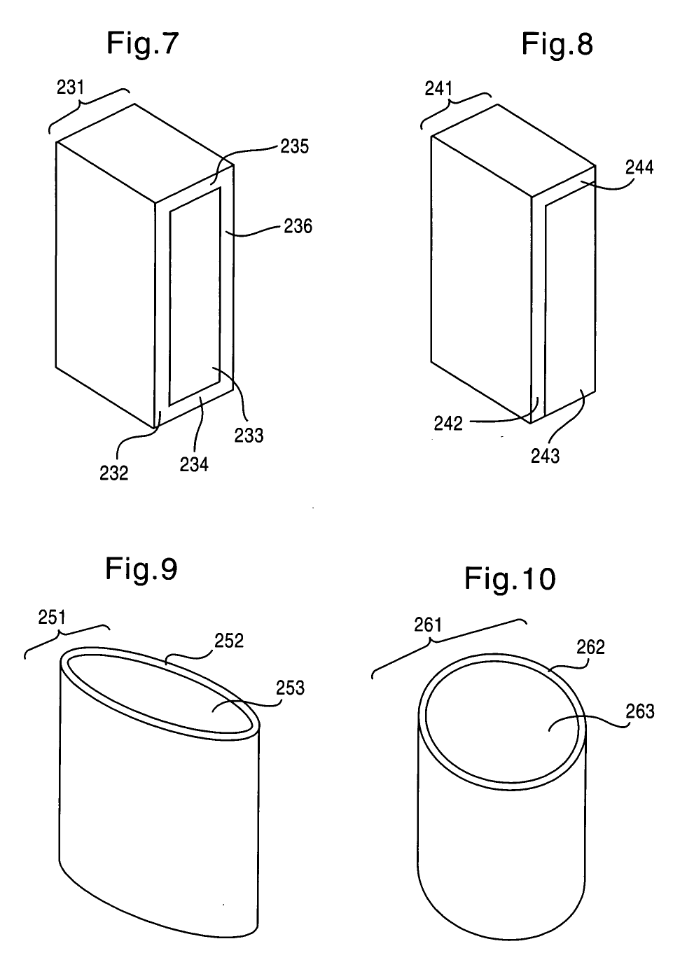

Another example of the gas diffusion layer 231 of the invention is shown in FIG. 7. The flexible, electrically non-conductive, porous material 233 has a rectangular shape having four side external surfaces and two end external surfaces, wherein two opposite side external surfaces and both end external surfaces are coated with one or more layers of the electrically conductive material 232, 236, 234, 235, wherein the internal surfaces may or may not be coated with the electrically conductive material.

In still another example of the gas diffusion layer of the invention, the flexible, electrically non-conductive, porous material has a rectangular shape having four side external surfaces and two end external surfaces, wherein the four side external surfaces and both end external surfaces are coated with one or more layers of the electrically conductive material, wherein the internal surfaces may or may not be coated with the electrically conductive material.

Another embodiment of the gas diffusion layer 241 is shown in FIG. 8. The flexible, electrically non-conductive, porous material 243 has a rectangular shape having four side external surfaces and two end external surfaces, wherein one of the side external surfaces and one of the end external surfaces are coated with one or more layers of the electrically conductive material 242, 244, wherein the internal surfaces may or may not be coated with the electrically conductive material.

Another example of the gas diffusion layer 251 of the invention has the flexible, electrically non-conductive, porous material 253 in the shape of a structure having a curved external surface, two end external surfaces contiguous with the curved external surface and an oval horizontal cross section, wherein at least a portion, or preferably substantially all, of the curved external surface is coated with the electrically conductive material 252. Alternatively, at least a portion, or preferably substantially all, of at least one of the end external surfaces is coated with the electrically conductive material.

In another example of the gas diffusion layer 261 of the invention (see FIG. 10), the flexible, electrically non-conductive, porous material 263 is in the shape of a cylinder having a curved external surface and two end external surfaces, wherein at least a portion, or preferably substantially all, of the curved external surface is coated with the electrically conductive material 262. Alternatively, at least a portion, or preferably substantially all, of at least one of the end external surfaces is coated with the electrically conductive material.

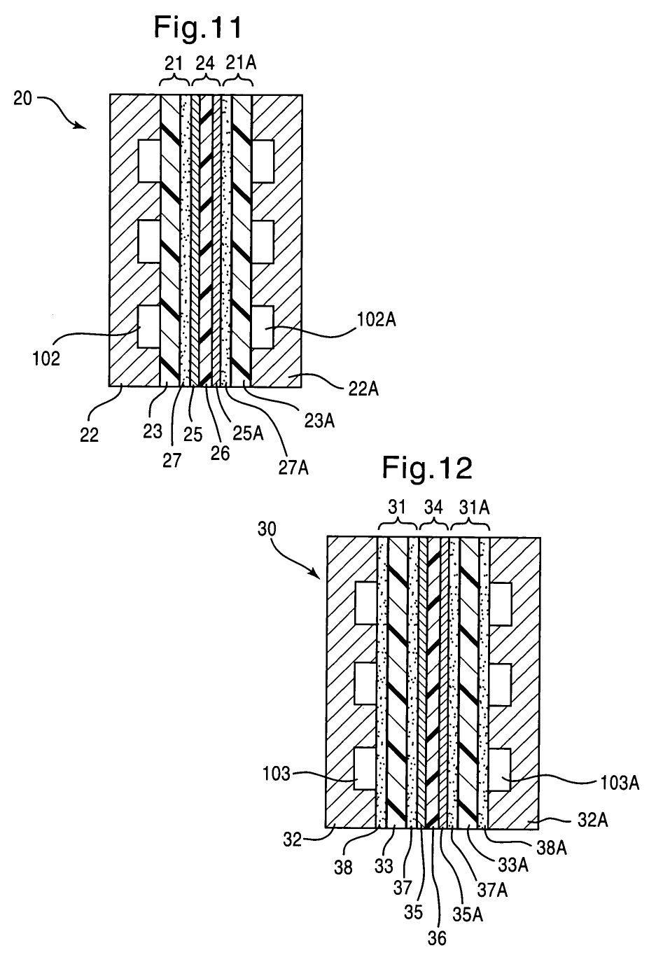

FIG. 11 shows an embodiment of the fuel cell 20 of the invention having two gas diffusion layers shown in FIG. 4 inside. An external side surface of a flexible, electrically non-conductive material 23 of a gas diffusion layer 21 is substantially entirely coated with an electrically conductive material and in contact with an anode 25. An opposite external side surface of the porous material 23 is in contact with a bipolar plate 22 having flow fields, one of which is labeled as 102, wherein at least a portion, preferably substantially all, of the internal surfaces of the porous material 23 of the gas diffusion layer 21 coated with the electrically conductive material is in contact with the bipolar plate 22. Similarly, an external side surface of a flexible, electrically non-conductive material 23A of the gas diffusion layer 21 A is substantially entirely coated with an electrically conductive material and in contact with a cathode 25A. An opposite external side surface of porous material 23A is in contact with a bipolar plate 22A having flow fields, one of which is labeled as 102A, wherein at least a portion, preferably substantially all, of the internal surfaces of the porous material 23A of the gas diffusion layer 21A coated with the electrically conductive material is in contact with the bipolar plate 22A. The anode 25 and cathode 25A sandwich a PEM 26, which together form a MEA 24.

FIG. 12 shows an embodiment of the fuel cell 30 of the invention having two gas diffusion layers shown in FIG. 5 inside. An external major side surface of a flexible, electrically non-conductive material 33 of the gas diffusion layer 31 is substantially entirely coated with a film 37 of an electrically conductive material and in contact with an anode 35. An opposite external major side surface of the porous material 33 is coated with a film 38 of the electrically conductive material and is in contact with a bipolar plate 32 having flow fields, one of which is labeled as 103. At least a portion, preferably substantially all, of the internal surfaces of the porous material 33 of the gas diffusion layer 31 is coated with the electrically conductive material so that the at least a portion of the internal surfaces and the two coated side external surfaces form an electrically conductive pathway in connection with the bipolar plate 32. Similarly, an external major side surface of a flexible, electrically non-conductive material 33A of the gas diffusion layer 31A is coated with a film 37A of the electrically conductive material and in contact with a cathode 35A. An opposite external major side surface of porous material 33A is substantially entirely coated with the electrically conductive material and is in contact with a bipolar plate 32A having flow fields, one of which is labeled as 102A. At least a portion, preferably substantially all, of the internal surfaces of the porous material 33A of the gas diffusion layer 31A is coated with the electrically conductive material and in contact with the bipolar plate 32A, wherein the at least a portion of the internal surfaces and the two coated side external surfaces form an electrically conductive pathway in connection with the bipolar plate 32A. The anode 35 and cathode 35A sandwich a PEM 36, which together form a MEA 34.

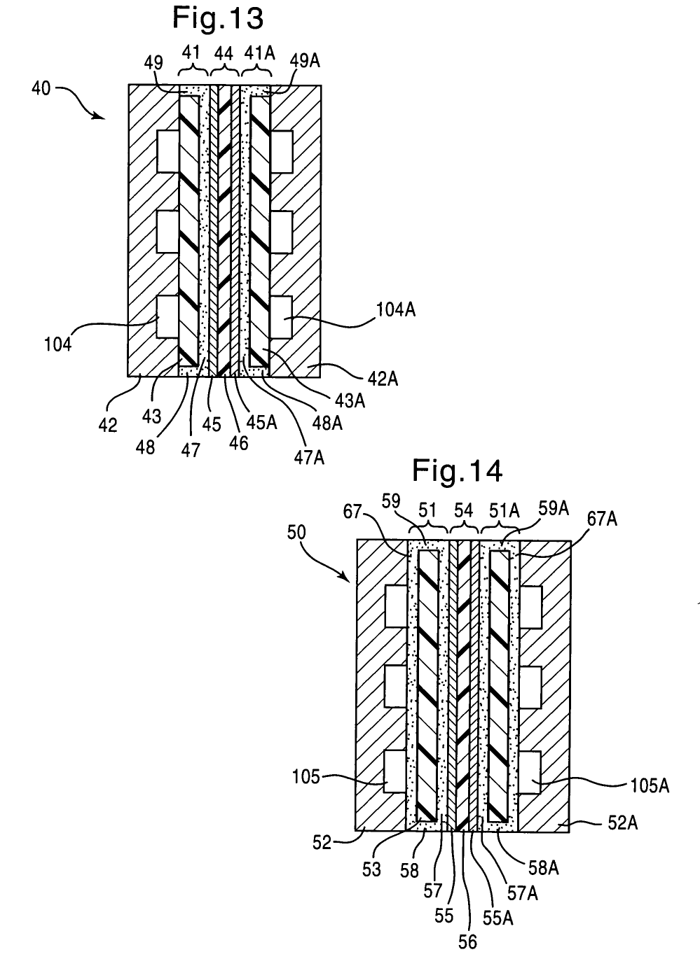

FIG. 13 shows another embodiment of the fuel cell 40 of the invention having two gas diffusion layers shown in FIG. 6 inside. An external side surface of a flexible, electrically non-conductive material 43 of the gas diffusion layer 41 is substantially entirely coated with an electrically conductive material 47 and in contact with an anode 45. Two opposite end external surfaces of the porous material 43 are substantially entirely coated with two films 48, 49 of the electrically conductive material and are in contact with a bipolar plate 42 having flow fields, one of which is labeled as 104, wherein optionally at least a portion, preferably substantially all, of the internal surfaces of the porous material 43 of the gas diffusion layer 41 is coated with the electrically conductive material and is in contact with the bipolar plate 42. Similarly, an external major side surface of a flexible, electrically non-conductive material 43A of the gas diffusion layer 41A is substantially entirely coated with a film 47A of the electrically conductive material and in contact with a cathode 45A. Two opposite end external surfaces of the porous material 43A are substantially entirely coated with two films 48A, 49A of the electrically conductive material and are in contact with a bipolar plate 42A having flow fields, one of which is labeled as 104A, wherein optionally at least a portion, preferably substantially all, of the internal surfaces of the porous material 43A of the gas diffusion layer 41A is coated with the electrically conductive material and is in contact with the bipolar plate 42A. The anode 45 and cathode 45A sandwich a PEM 46, which together form a MEA 44.

FIG. 14 shows another embodiment of the fuel cell 50 of the invention having two gas diffusion layers shown in FIG. 7 inside. Two opposite major external side surfaces of a flexible, electrically non-conductive material 53 of the gas diffusion layer 51 are substantially entirely coated with films 57, 67 of an electrically conductive material and the film 57 is in contact with an anode 55. Two opposite external end surfaces of the porous material 53 are substantially entirely coated with films 58, 59 of the electrically conductive material and in contact with a bipolar plate 52 having flow fields, one of which is labeled as 105. Optionally, at least a portion, preferably substantially all, of the internal surfaces of the porous material 53 of the gas diffusion layer 51 is coated with the electrically conductive material so that the at least a portion of the internal surfaces, the two coated major external side surfaces and the two coated external end surfaces form an electrically conductive pathway in connection with the bipolar plate 52. Similarly, two opposite external major side surfaces of a flexible, electrically non-conductive material 53A of the gas diffusion layer 51A are substantially entirely coated with films 57A, 67A of an electrically conductive material and the surface coated with film 57A is in contact with a cathode 55A. Two opposite external end surfaces of porous material 53A are substantially entirely coated with films 58A, 59A of the electrically conductive material and in contact with a bipolar plate 52A having flow fields, one of which is labeled as 105A. Optionally, at least a portion, preferably substantially all, of the internal surfaces of the porous material 53A of the gas diffusion layer 51A is coated with the electrically conductive material and in contact with the bipolar plate 52A, wherein the at least a portion of the internal surfaces, the two coated major external side surfaces and the two coated external end surfaces form an electrically conductive pathway in connection with the bipolar plate 52A. The anode 55 and cathode 55A sandwich a PEM 56, which together form a MEA 54.

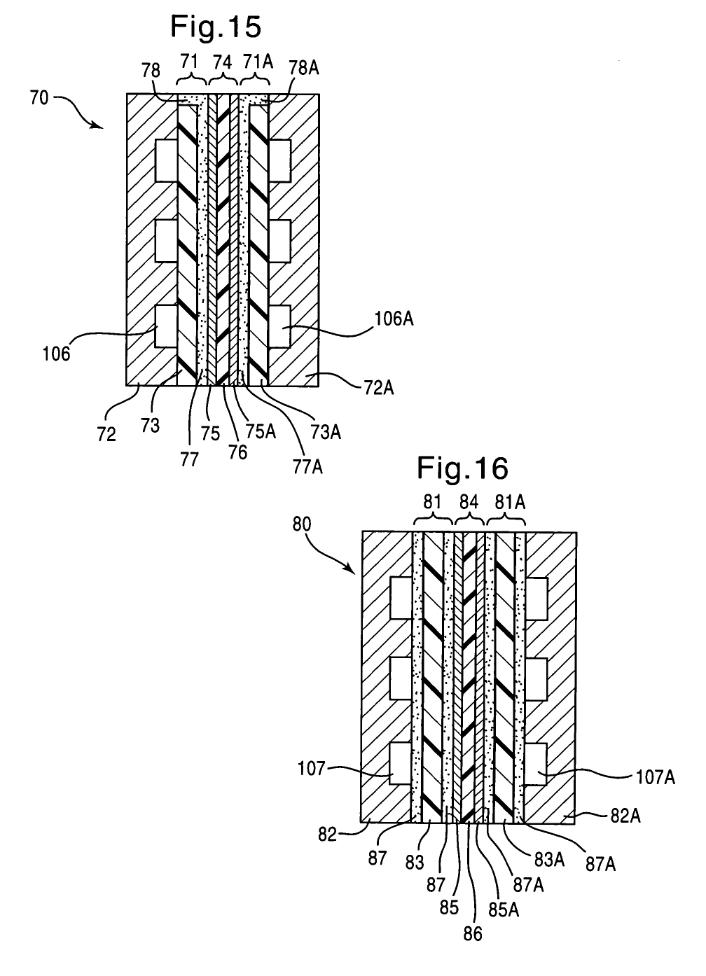

FIG. 15 shows another embodiment of the fuel cell 70 of the invention having two gas diffusion layers shown in FIG. 8 inside. An external side surface of a flexible, electrically non-conductive material 73 of the gas diffusion layer 71 is substantially entirely coated with film 77 of an electrically conductive material and in contact with an anode 75. Two opposite end external surfaces of the porous material 43 are coated with two films 48, 49 of the electrically conductive material and are in contact with a bipolar plate 42 having flow fields, one of which is labeled as 104, wherein optionally at least a portion, preferably substantially all, of the internal surfaces of the porous material 43 of the gas diffusion layer 41 is coated with the electrically conductive material and is in contact with the bipolar plate 42. Similarly, an external side surface of a flexible, electrically non-conductive material 43A of the gas diffusion layer 41A is coated with a film 47A of the electrically conductive material and in contact with a cathode 45A. Two opposite end external surfaces of the porous material 43A are coated with two films 48A, 49A of the electrically conductive material and are in contact with a bipolar plate 42A having flow fields, one of which is labeled as 104A, wherein optionally at least a portion, preferably substantially all, of the internal surfaces of the porous material 43A of the gas diffusion layer 41A is coated with the electrically conductive material and is in contact with the bipolar plate 42A. The anode 45 and cathode 45A sandwich a PEM 46, which together form a MEA 44.

FIG. 16 shows an embodiment of the fuel cell 80 of the invention having two gas diffusion layers shown in either FIG. 9 or 10 inside. The two gas diffusion layers of either FIG. 9 or 10 are compressed when inserted into the fuel cell. An external curved side surface of a flexible, electrically non-conductive material 83 of the gas diffusion layer 81 is substantially entirely coated with a film 87 of an electrically conductive material, wherein the same film 87 is in contact with an anode 85 and a bipolar plate 82 on opposite sides of the gas diffusion layer 81, and wherein the bipolar plate 82 has flow fields, one of which is labeled as 107. Optionally, at least a portion, preferably substantially all, of the internal surfaces of the porous material 83 of the gas diffusion layer 81 is coated with the electrically conductive material so that the at least a portion of the internal surfaces and the film 87 of the coated external curved surface form an electrically conductive pathway in connection with the bipolar plate 82. Similarly, an external curved side surface of porous material 83A of gas diffusion layer 81A is substantially entirely coated with a film 87A of the electrically conductive material, wherein the same film 87A is in contact with a cathode 85A and a bipolar plate 32A having flow fields, one of which is labeled as 102A. Optionally at least a portion, preferably substantially all, of the internal surfaces of the porous material 83A of the gas diffusion layer 81A is coated with the electrically conductive material and in contact with the film 87A, so that the at least a portion of the internal surfaces and the coated external curved side surfaces form an electrically conductive pathway in connection with the bipolar plate 82A. The anode 85 and cathode 85A sandwich a PEM 86, which together form a MEA 84.

It is noted that the lower the resistivity of a film coating the surface of a flexible, electrically non-conductive, porous material, the better the expected performance of the material as a gas diffusion layer in PEM fuel cells. Higher resistivity leads to greater parasitic power losses and heat generation. In contrast, it is also noted that the higher the gas permeability, the better the expected performance of the material as a gas diffusion layer in PEM fuel cells. Higher gas permeability means better flow of fuel (hydrogen gas) to the anode and better flow of oxygen to, and water vapor away from the cathode in the fuel cell.

### EXAMPLE 1

As an example of the flexible, electrically non-conductive, porous material that can be used to make a gas diffusion layer of the invention, a 70 pore per linear inch reticulated polyether polyurethane foam was prepared from the following ingredients:

| | | |
|---|---|---|
| Arcol 3020 polyol (from Bayer Corp.) | 100 | parts |
| Water | 4.7 | parts |
| Dabco NEM (from Air Products) | 1.0 | part |
| A-1 (from GE Silicone/OSi Specialties) | 0.1 | parts |
| Dabco T-9 (from Air Products) | 0.17 | parts |
| L-620 (from GE Silicone/OSi Specialties) | 1.3 | parts |

Arcol 3020 polyol is a polyether polyol triol with a hydroxyl number of 56 having a nominal content of 92% polypropylene oxide and 8% polyethylene oxide. Dabco NEM is N-ethyl morpholine. A-1 is a blowing catalyst containing 70% bis (dimethylaminoethyl)ether and 30% dipropylene glycol. Dabco T-9 is stabilized stannous octoate. L-620 represents is a high efficiency non-hydrolyzable surfactant for conventional slabstock foam. After mixing the above ingredients for 60 seconds and allowing the mixed ingredients to degas for 30 seconds, 60 parts of toluene diisocyanate were added. This mixture was mixed for 10 seconds and then placed in a 15″ by 15″ by 5“box to rise and cure for 24 hours. The resulting foam had a density of 1.4 pounds per cubic foot.

Similarly, an 88 pore per linear inch polyurethane foam was made and felted to firmness 6 (compressed to one-sixth of its original thickness) with a final thickness of 2 mm. The felted foam was perforated with 113 one-millimeter diameter holes per square inch, with a total perforated void volume of 18%. The felted and perforated foam could be used as the flexible, electrically non-conductive, porous material for making the gas diffusion layer of the invention.

### EXAMPLE 2

A number of formulations containing conductive carbon particles was prepared and the electrical resistance (R) of films formed from the formulations were determined. Some of these formulations can be used to coat a flexible, electrically non-conductive, porous media to make the gas diffusion layer of the invention. The resistance (R) value was the meter reading when probes were placed 1 cm apart on the film surface. The dried film thickness (DFT) was given. Generally, resistance decreased at higher thickness. Optimization was aimed at achieving lower resistance at lower DFTs.

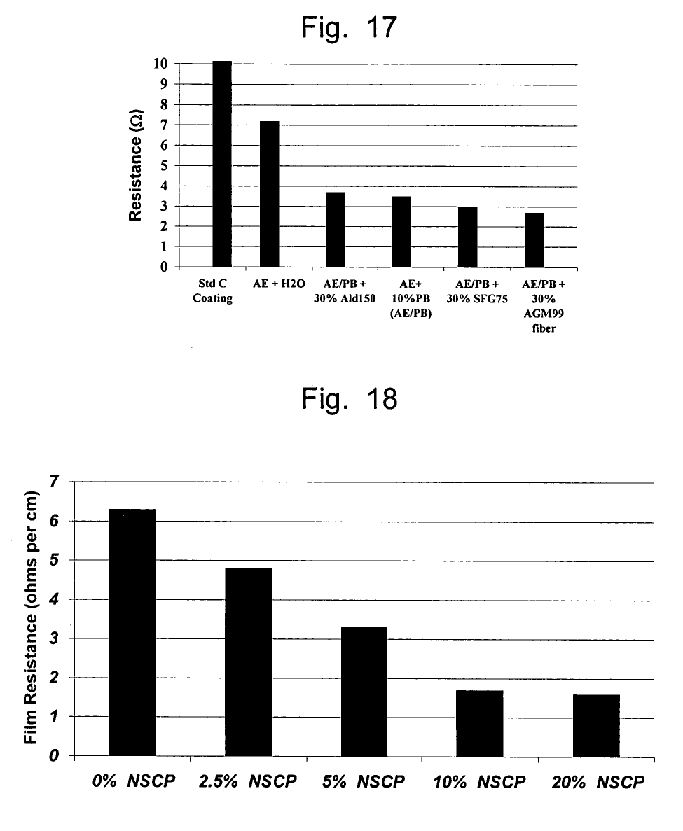

Formulation AE/PB, i.e. AE blended with 10 wt %, based on solids, of PB, was used to form a conductive coating, in which the resistance, R, was measured. Next, various “conductivity additive” powders were used in conjunction with the AE/PB blend to see if R could still be lowered further. Table 3a shows the effects of adding 30 wt %, based on solids, of an additional powder to the AE/PB blend. FIG. 17 further illustrates this effect by comparing normalized R values for each coating formulation.

TABLE 3a
Dried Film Data for Various “Conductivity Additive” Blends with AE/PB****

| Code | Solid | R (ohm | DFT | Dry Film | |
|---|---|---|---|---|---|
| Name | Ingredients* | per cm) | (mil**) | (g) | Comments |
| 206- | 100% AE/PB | 5.5 | 25 | 0.9 | Control, good mechanical |
| 24A | | | | | properties |
| 206- | 70% AE/PB + 30% | 3.7 | 35 | 1.2 | Smaller islands than 206- |
| 24B | Aldrich 150 | | | | 24A, rougher surface, flake |
| | | | | | rich bottom |
| 206- | 70% AE/PB + 30% | 4.3 | 34 | 1.2 | More continuous surface |
| 24C | T-150 | | | | than 206-24A, smooth |
| | | | | | surface |
| 206- | 70% AE/PB + 30% | 3.4 | 31 | 1.2 | Very good mechanical |
| 24D | SFG-75 | | | | properties, smooth surface; |
| | | | | | less rub than 206-24D |
| 206- | 70% AE/PB + 30% | 2.9 | 32 | 1.2 | Smoothest, most |
| 24E | AGM99*** | | | | continuous, good strength; |
| | | | | | moderate rub |

*In percent of total solid weight
**1 Mil = 0.001 inch or 0.0254 mm
***AGM99 was 7 μm × 150 μm carbon fiber
****See paragraph [0027] and Table 2 for material notations

TABLE 3b
Film Resistance
Normalized to DFT = 35 mils

| Key | R (ohm per cm) |
|---|---|
| Std C Coating | 10.3 |
| AE + H2O | 7.2 |
| AE/PB + 30% Ald150 | 3.7 |
| AE + 10% PB (AE/PB) | 3.5 |
| AE/PB + 30% SFG75 | 3.0 |
| AE/PB + 30% AGM99 | 2.7 |

In Table 3b and FIG. 17, a standard carbon coating from Foamex International, which used an amorphous carbon black (D50%=0.446 μm, D90%=0.960 μm), is shown for comparison.

Addition of 30 wt % of an additional powder to the AE/PB formulation resulted in a film with significantly lower R and improved mechanical properties (low rub, strength). Table 4 shows data for the blends.

TABLE 4
Results of Several AE/PB Blends

| | | | | Dry |
|---|---|---|---|---|
| | | R | DFT | film |
| Code | Solid Ingredients* | (Ω per cm) | (mil) | (g) |
| 206-24A | 100% AE/PB | 5.5 | 25 | 0.9 |
| 206-24D | 70% AE/PB + 30% SFG-75 | 3.4 | 31 | 1.2 |
| 206-62J | 25% AE/PB + 75% SFG-75 | 2 | 43 | 1.3 |
| 206-24E | 70% AE/PB + 30% AGM99 | 2.9 | 32 | 1.2 |
| 206-62D | 25% AE/PB + 75% AGM99 | 1.8 | 50 | 1.3 |

*In percent of total solid weight

Table 4 shows that Formulation 206-62J, i.e. 25% AE/PB+75% SFG-75, resulted in a film, which had low contact R and good mechanical properties, in this experiment. This formulation was the most conductive small particle size coating among the coating formulations tested in this experiment and will be referred to as the Small PSD formulation.

In an effort to further optimize coating properties (low R and a good film), experiments were conducted to study a variety of carbon powders. The objective was to determine which individual powder was most conductive and how packing density affected conductivity.

Powders were obtained from a variety of suppliers including Timeal Graphite, Superior Graphite, and Asbury Carbons. A 1 cm (internal diameter) tube was used, with nail heads on both ends attached to leads from a Sperry DM-4100A voltmeter. Powder compacts were prepared by sprinkling powder in to fill a constant volume. A reading was measured when the powder filled separation between nail heads was 1 cm. This method allows comparison of relative resistance values and the ability to calculate an apparent density. Tables 5a-5c show results for the conductive powder candidates.

TABLE 5a
Physical Properties of Powder Compacts

| | | | Apparent Density |
|---|---|---|---|
| Large Flake | Particle Size | R at Contact (Ω) | (g/cm³) |
| A3459 | D90% = 400 μm | 21.2 | 0.8549 |
| Timcal T-150 | D90% = 180 μm | 24.7 | 0.4275 |
| Aldrich 150 | D90% = 150 μm | 36.7 | 0.6362 |

TABLE 5b
Physical Properties of Powder Compacts

| | | R at Contact | Apparent Density |
|---|---|---|---|
| Medium Sized Powder | Particle Size | (Ω) | (g/cm³) |
| A4956 Graphitized | D90% = 75 μm | 24.8 | 0.8549 |
| Coke | | | |
| A4957 Graphitized | D90% = 40 μm | 31.4 | 0.5368 |
| Coke | | | |
| Timcal SFG-75 | D90% = 60 μm | 33.4 | 0.3380 |

TABLE 5c
Physical Properties of Powder Compacts

| | | R | Apparent |
|---|---|---|---|
| | | at Contact | Density |
| Miscellaneous Powder | Particle Size | (Ω) | (g/cm³) |
| Asbury AGM99 Fiber (PAN) | 7 μm × 150 μm | 42.9 | 0.5368 |
| Asbury AGM95 Fiber (pitch) | 13 μm × 200 μm | 36.5 | 0.6362 |
| NSCP Amorphous Carbon | D50% = 0.03 μm | 49 | 0.1590 |
| Black | | | |

The rating criteria for most conductive powder not mixed with other powders were 1) low contact resistance; most closely represents powder packing as film forms; and 2) density for good packing. The best conductive filler should have low contact resistance with low density and small size.

The powders listed in Tables 4a-4c were further classified by particle size and morphology. The larger Particle Size Distribution (PSD) materials, especially graphite flake, formed the densest and most conductive powder compacts. The objective for the next round of experiments was to find the most conductive blend of powders to form a basis for a conductive coating formulation. Using E-chip's™ Design of Experiment software and the same method used in Tables 5a-5c, three blends were selected and confirmed by measurement. Table 6a contains the data for the three selected blends. Table 6b shows the density of the individual powder components.

TABLE 6a
Three Selected Blends

| | Contact Resistance | Density |
|---|---|---|
| Solid Ingredients* | (Ω) | (g/cm³) |
| 1. 60% A3459 + 20% A4957 + 20% | 12 | 0.7952 |
| AGM99 | | |
| 2. 80% A3459 + 20% A4956 | 15.2 | 0.8549 |
| 3. 80% A3459 + 20% A4957 | 16.1 | 0.6362 |

*In percent of total solid weight

TABLE 6b
Density of Powder

| Powder | Density (g/cm³) |
|---|---|
| A3459 | 0.8549 |
| A4956 | 0.8549 |
| A4957 | 0.5368 |
| AGM99 | 0.5368 |
| AGM95 | 0.6362 |

Within experimental error, Blends 1, 2 and 3 in Table 6a were equivalent. They should result in equivalent film resistance. The next step was to formulate a coating based on these blends and compare film resistance.

When Blend 1 was used in a formulation to coat a surface, a densely packed film structure having a low resistance (8.9 ohms per cm), without voids, was produced. However, when the AGM99 fiber in Blend 1 was replaced with AGM95 fiber and the resulting blend was put in a formulation to coat a surface, a film having a higher resistance (˜20 ohms per cm) and large void volume with poor film structure was obtained. This further reiterates the need for density matching to obtain good film properties. Note that various particle-sized powders and blends can be used to obtain similar low resistance high-density compacts.

Coating Formulations

Blends 1 and 3 were used to formulate 2 candidate coatings. A blend containing no fiber would be advantageous from both a price and simplicity standpoint. Table 7a shows film results for coatings based on these blends. Blend 306-1A had 60% A3459: 20% A4957: 20% AGM99 by solid weight. Some issues with the blend include poor film strength, tendency for large flake to sink to bottom, and viscosity stability of the coating.

TABLE 7a
Film Results

| | | R (Ω per | DFT | Dry Film |
|---|---|---|---|---|
| Code | Solid Ingredients* | cm) | (mil) | (g) |
| 306- | 60% A3459:20% A4957:20% | 8.9 | 42 | 1.3 |
| 1A | AGM99 | | | |
| 306- | 65% A3459:25% A4957:10% | 6.3 | 41 | 1.3 |
| 1B | AGM99 | | | |
| 306- | 80% A3459:20% A4957 | 8.5 | 44 | 1.2 |
| 1C | | | | |

*In percent of total solid weight

By comparing 306-1A with 306-1B, it was noted that increasing the amount of A3459 flake seems to further decrease resistance, while also decreasing the amount of expensive fiber necessary. A comparison of 306-1A with 306-1C indicates that fibers may not contribute to lower film resistance.

A non-fibrous, submicronic amorphous carbon black powder having primary carbon particles with D50% of about 0.03 μm (herein referred to as NSCP), available as XC-72 from Cabot Corporation, was tested as an example of one of the populations of electrically conductive, non-fibrous carbon particles used in the invention. The NSCP has a high surface area. When incorporated into a conductive carbon coating formulation, the NSCP significantly raises viscosity. This aids in stabilizing the coating and suspending the denser large particle size graphite. Table 7b shows the effects of adding the NSCP to the 65% A3459:25% A4957:10% AGM99 blend, 306-1B. Clearly, adding the NSCP resulted in significantly lower film resistance.

TABLE 7b
Effects of Addition of the NSCP

| | | R (Ω | | Dry |
|---|---|---|---|---|
| | | per | DFT | Film |
| Code | Solid Ingredients* | cm) | (mil) | (g) |
| 306- | 65% A3459:25% A4957:10% AGM99:0% | 6.3 | 41 | 1.3 |
| 1B | NSCP | | | |
| 306- | 62.5% A3459:25% A4957:10% | 4.8 | 49 | 1.1 |
| 4B | AGM99:2.5% NSCP | | | |
| 306- | 62% A3459:23% A4957:10% AGM99:5% | 3.3 | 37 | 1.1 |
| 4C | NSCP | | | |
| 306- | 65% A3459:20% A4957:5% AGM99:10% | 1.7 | 32 | 1.2 |
| 6D | NSCP | | | |
| 306-6I | 61% A3459:15% A4957:4% AGM99:20% | 1.6 | 33 | 1.1 |
| | NSCP | | | |

*In percent of total solid weight

FIG. 18 shows that the film R of the 10% NSCP blend seemed equivalent to the 20% NSCP blend (comparing 306-6D with 306-61). Preferably, the content of the NSCP is about 10% of the total solid weight. The film's mechanical properties (density and strength) seemed to improve with higher concentrations of the NSCP. Formulation 306-6D performed best, indicating a target ratio of 65% A3459:20% A4957:5% AGM99:10% NSCP for a 4-component formulation. Data in Table 7a indicate that a 2-component blend of carbon flake and the NSCP should outperform the 4-component mix.

Two coating formulations were prepared. TC-131 contained the 4-component blend mentioned above (“TC” stands for Test Coating and indicates a batch prepared on a laboratory scale). TC-139 was a 2 component batch containing 86% A3459:14% NSCP. TC-146 was another 2 component batch containing 86% large carbon flake:14% NSCP, wherein the large carbon flake is smaller than A3459 used in TC-139. Table 7c summarizes the film data.

TABLE 7c
Film Data Comparison for Various Formulations

| | | | | Dry |
|---|---|---|---|---|
| | | R (Ω per | DFT | Film |
| Code | Solid Ingredients* | cm) | (mil) | (g) |
| 206-62J (Small | 25% AE/PB + 75% SFG75 | 2 | 43 | 1.3 |
| PSD) | | | | |
| 306-58A (TC- | 65% A3459:20% A4957:5% | 1.7 | 39 | 1.2 |
| 131) | AGM99:10% NSCP | | | |
| 312-15F (TC- | 86% A3459:14% NSCP | 1.2 | 43 | 1.2 |
| 139) | | | | |
| 311-34D (TC- | 86% 140 μm C flakes**:14% | 1 | 38 | 1.2 |
| 146) | NSCP | | | |

*In percent of total solid weight
**Size-selected 3160, a carbon flake with D50% = 91 μm and D90% = 140 μm

### EXAMPLE 3

The concept of using a larger PSD flake in conjunction with smaller amorphous carbon had been validated. Smaller PSD coatings tend to have better storage, viscosity stability, and better physical properties than large PSD formulations. A large PSD formulation with these properties is desirable.

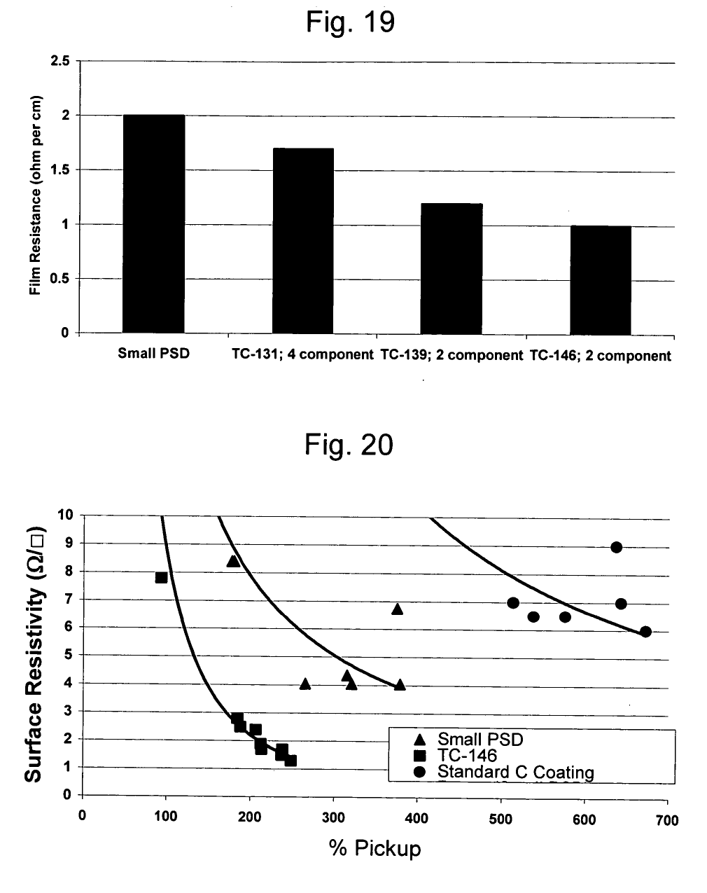

Various sized flakes were compounded into similar coating formulations. The goal of this experiment was to select the most conductive flake for a formulation in which the carbon solids weight ratio was 86:14 flake: NSCP. Flakes evaluated had a D50% of about 5, 20, 50, 91, 114, 144, 210, and 241 μm. The most drastic decrease in film resistance occurred with flakes having D50% between about 50 μm and about 90 μm, e.g. 91 μm. Coating formulations with flakes D50% above 91 μm all had similar low film resistance within experimental error. TC-146 was formulated using carbon flake with a D50% of 91 μm and D90% of 140 μm and the NSCP, and was expected to give the lowest resistance and most stable coat. FIG. 19 compares the resistance trend of the various formulations developed and further illustrates the trend toward lower film resistance.

FIG. 20 compares the surface resistivity of a film on a felt made by coating the felt with one of three optimized formulations. Surface Resistivity is plotted as a function of percent Pickup (coating weight gain) for felts of similar thickness. TC-146 clearly had lower resistivity at lower percent pickup than the standard carbon coating or Small PSD formulation. It had less flake-off than the Small PSD formulation. TC-146 can be used to form the electrically conductive material coating at least a portion of at least one external surface of a flexible, electrically non-conductive, porous material to obtain a structure, e.g. a GDL or GDE, for a fuel cell according to the invention.

### EXAMPLE 4

Carbon paper and cloth are very expensive to manufacture. Coated foam GDLs would be less expensive to manufacture in a simpler process. These materials would not be as brittle or difficult to work with as the current carbon paper standard. The GDL testing showed how compression, permeability (resistance to gas flow), and volume resistivity all vary with pressure load.

In fuel cells, pressure is applied to hold the various layers of the fuel cell together. GDL testing of the coated felt was useful to understand its properties under different pressure loads. The test jig included two conductive metal plates. A spring was attached to the top plate. By compressing the spring, various pressure loads can be applied to the sample. A disk was cut out of both the upper and lower plate. There was a flow path from a gas source (air or N₂), connected to an open air manometer which measures pressure drop in millimeters of water. Pressure drop of water (in mm) was measured against the bottom metal screen. Observer error was ±0.5 mm. When no GDL was present the apparatus read a 3-4 mm pressure drop. The sample was placed between the 2 plates. Finally, the plate leads were connected to a Maccor Model MC-4 Battery Test system, which measured the resistance through the thickness of the sample.

Typical stack pressures for fuel cells range from 1 to 120 psi (0 to 8 kg/cm²). A feeler gauge was used to measure gap distance (z). A 2-inch square sample was used for testing.

Volume resistivity (VR) is a material property. It eliminates dimensionality and has units of Ω cm. Surface resistivity (Ω/O) ignores dimensions (as long as all samples are of the same thickness and the length equals the width).

For a pressure probe set-up, when the electric potential (V) is measured and the electric current (I) is constant, the resistance equals to V/I. The volume resistance or volume resistivity, VR, can be calculated with the following formula:
VR=(R*x*y)/z, where
R=measured resistance in Ω
x=sample width in cm
y=sample length in cm
z=sample thickness in cm, i.e. probe spacing by feeler gage
xy=cross-sectional area in cm²
VR=volume resistance or volume resistivity in Ω cm

The Small PSD coated felt and TC-146 (Large PSD) coated felt, both of which felts about 2 mm thick, were compared with standard carbon paper (Ballard's Avcarb carbon fiberpaper wet proofed with 30% PTFE by weight at a 0.22 mm thickness) and cloth (Toray's carbon cloth, an untreated satin-weave 0.8 mm thick cloth) GDL materials.

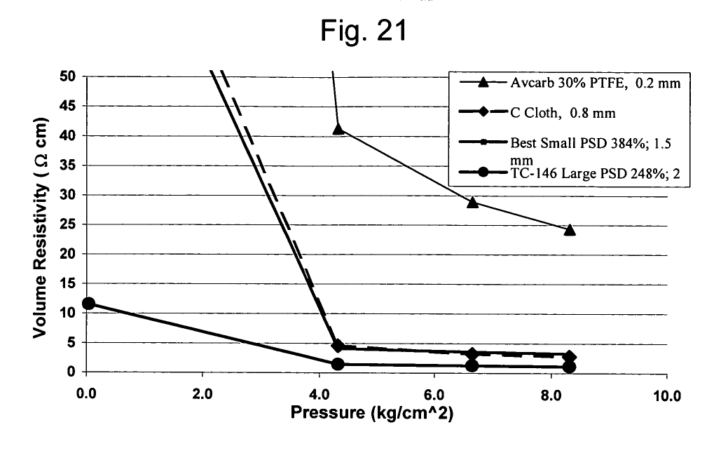

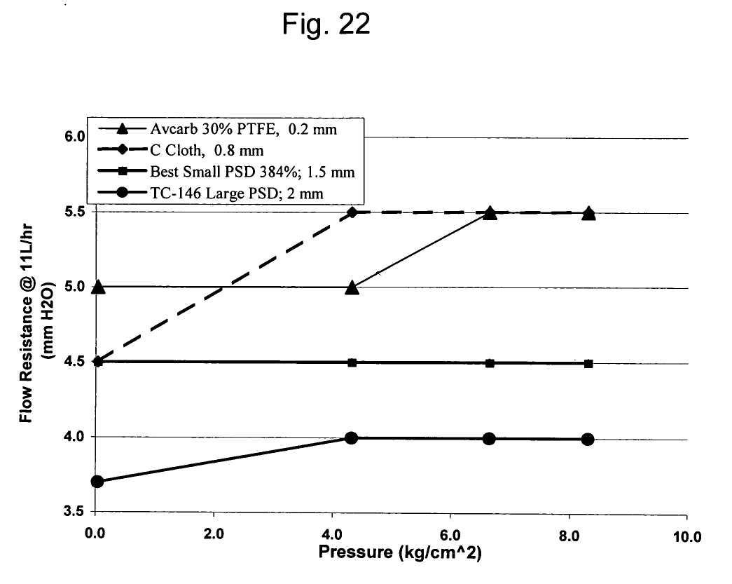

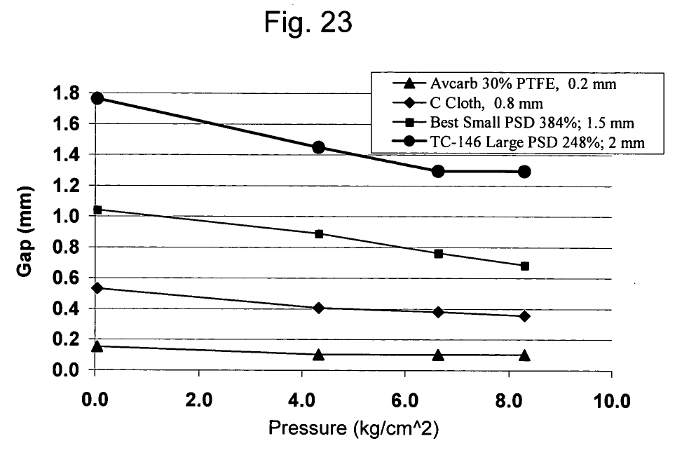

FIGS. 21-23 illustrate the effect of pressure load as a function of volume resistivity, flow resistance, and compression. Table 8, displayed at the end of the specification, is a compilation of data for the four GDL materials tested. The row entitled “Apparatus Baseline” in Table 8 contains data taken without any GDL sample in the apparatus. Table 8 presents the raw resistance, volume resistivity, compression and resistance to nitrogen flow maintained at a flow rate of 10-12 L/hour when a pressure of 0.04, 4.3 or 8.3 kg/cm² was applied. The results show that, in terms of both volume resistivity and airflow resistance (the resistance to nitrogen flow and airflow were almost identical), the TC-146 coated felt performed better than either carbon paper or carbon cloth.

Foam is inherently more flexible, easier to fabricate into various geometries, easier to manufacture, and less costly than the carbon paper or carbon cloth. Using a larger graphite flake (lower internal resistance), blended with smaller graphite and/or amorphous carbon results in a significantly lower film resistance. Without being limited to any theoretical mechanism, this was probably due to both higher packing density and the combination of lower internal resistance (larger) flakes with the smaller conductive carbon particles.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

TABLE 8
Results of GDL Comparison

| | | Measured | Volume | | Flow |
|---|---|---|---|---|---|
| | | Resistance | Resistivity | | Resistance |
| Flow rate 10-12 L/hr N2 | | (mΩ) | (Ω cm) | Compression % | (mm H2O) |
| Apparatus Baseline | 0.04 kg/cm\hat{ }2 | 1.68 | | | 3.5 |
| | 4.3 kg/cm\hat{ }2 | 0.76 | | | 4 |
| | 8.3 kg/cm\hat{ }2 | 0.76 | | | 4 |
| C paper Avcarb | 0.04 kg/cm\hat{ }2 | 270.7 | 459.5 | 20 | 5 |
| 30% PTFE Wet-proof | 4.3 kg/cm\hat{ }2 | 16.3 | 41.3 | 46 | 5 |
| 0.22 mm thickness | 8.3 kg/cm\hat{ }2 | 9.62 | 24.3 | 46 | 5.5 |
| C cloth | 0.04 kg/cm\hat{ }2 | 215 | 104.1 | 37 | 4.5 |
| 0.8 mm thickness | 4.3 kg/cm\hat{ }2 | 7.17 | 4.56 | 52 | 5.5 |
| | 8.3 kg/cm\hat{ }2 | 3.82 | 2.77 | 58 | 5.5 |
| 1.5 mm Small PSD | 0.04 kg/cm\hat{ }2 | 388.5 | 96.3 | 49 | 4.5 |
| Felt 384% Pickup | 4.3 kg/cm\hat{ }2 | 14.2 | 4.12 | 64 | 4.5 |
| | 8.3 kg/cm\hat{ }2 | 8.69 | 3.27 | 64 | 4.5 |
| 2 mm TC-146 | 0.04 kg/cm\hat{ }2 | 78.9 | 11.5 | 24 | 3.7 |
| 248% pickup | 4.3 kg/cm\hat{ }2 | 8.09 | 1.44 | 38 | 4 |
| | 8.3 kg/cm\hat{ }2 | 5.64 | 1.12 | 44 | 4 |

1. A structure for a fuel cell, the structure comprising a flexible, electrically non-conductive, porous material having a solid matrix, interconnected pores or interstices through the solid matrix, at least one external surface and internal surfaces, which internal surfaces are the surfaces of the walls of the pores or interstices, wherein at least a portion of the at least one external surface is coated with one or more layers of an electrically conductive material,
the electrically conductive material comprising a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1:m, with m being at least 500;
(b) at least population C of electrically conductive non-fibrous carbon particles and population D of electrically conductive carbon fibers, wherein the ratio of the D50% of population C and the average length of the fibers of population D is 1:n, with n being at least 2; and
(c) at least population E of electrically conductive carbon fibers and population F of electrically conductive carbon fibers, wherein the ratio of the average length of the fibers of population E and the average length of the fibers of population F is 1:p, with p being at least 2.

2. The structure of claim 1, wherein m is at least 1000, n is at least 5 and p is at least 5.

3. The structure of claim 2, wherein m is at least 2000, n is at least 10 and p is at least 10.

4. The structure of claim 1, wherein the at least two populations are at least population A and population B.

5. The structure of claim 4, m being at least 2500.

6. The structure of claim 5, m being at least 3000.

7. The structure of claim 4, m ranging from about 2000 to about 4000.

8. The structure of claim 7, m ranging from about 2500 to about 3500.

9. The structure of claim 8, m ranging from about 3000 to about 4000.

10. The structure of claim 9, m ranging from about 3000 to about 3500.

11. The structure of claim 1, wherein the at least two populations are at least population C and population D.

12. The structure of claim 11, n being at least about 20.

13. The structure of claim 12, n being at least about 100.

14. The structure of claim 11, n ranging from about 100 to about 2000.

15. The structure of claim 14, n ranging from about 200 to about 2000.

16. The structure of claim 15, n ranging from about 500 to about 1000.

17. The structure of claim 1, wherein the at least two populations are at least population E and population F.

18. The structure of claim 17, p being at least 20.

19. The structure of claim 18, p being at least 50.

20. The structure of claim 1, wherein a content of the smallest population of the electrically conductive carbon particles in the electrically conductive material ranges from about 1% to about 50%, based on the dry weight of all the electrically conductive carbon particles.

21. The structure of claim 20, wherein the content of the smallest population of the electrically conductive carbon particles in the electrically conductive material ranges from about 5% to about 30%.

22. The structure of claim 21, wherein the content of the smallest population of the electrically conductive carbon particles in the electrically conductive material ranges from about 10% to about 20%.

23. The structure of claim 22, wherein the content of the smallest population of the electrically conductive carbon particles in the electrically conductive material ranges from about 10% to about 15%.

24. The structure of claim 4, wherein population A is a population of carbon black powder and population B is a population of carbon flakes.

25. The structure of claim 24, wherein the carbon black powder has a D50% of 0.01 to 0.05 μm and the carbon flakes have a D50% of 50 to 120 μm.

26. The structure of claim 24, wherein the carbon black powder has a D50% of about 0.03 μm and the carbon flakes have a D50% of about 90 μm.

27. The structure of claim 24, wherein the carbon black powder has a D50% of 0.01 to 0.05 μm and the carbon flakes have a D50% of 50 to 250 μm.

28. The structure of claim 24, wherein the carbon black powder has a D50% of about 0.03 μm and the carbon flakes have a D50% of about 90 μm to about 120 μm.

29. The structure of claim 27, wherein the electrically conductive material further comprises a population of electrically conductive carbon flakes having D50% of about 20 μm to about 90 μm.

30. The structure of claim 24, wherein the electrically conductive material further comprises a population of electrically conductive carbon fibers.

31. The structure of claim 30, wherein the carbon fibers have an average length of about 120 μm to about 200 μm, and an average diameter of about 3 μm to about 30 μm.

32. The structure of claim 1, wherein the flexible, electrically non-conductive, porous material is a polymeric material.

33. The structure of claim 32, wherein the polymeric material is selected from the group consisting of foams, bundled fibers, matted fibers, needled fibers, woven or nonwoven fibers, and porous polymers made by pressing polymer beads.

34. The structure of claim 33, wherein the polymeric material is selected from the group consisting of foams, bundled fibers and woven or nonwoven fibers.

35. The structure of claim 34, wherein the polymeric material is selected from polyurethane foams, melamine foams, polyvinyl alcohol foams, or nonwoven felts, woven fibers or bundles of fibers made of polyamide, polyethylene, polypropylene, polyester, cellulose, polyacrylonitrile, Rayon and mixtures thereof.

36. The structure of claim 35, wherein the polymeric material is a foam.

37. The structure of claim 36, wherein the polymeric material is a polyurethane foam.

38. The structure of claim 37, wherein the polymeric material is a felted polyurethane foam, reticulated polyurethane foam, or felted reticulated polyurethane foam.

39. The structure of claim 38, wherein the polymeric material is a felted reticulated polyurethane foam.

40. The structure of claim 37, wherein the polymeric material is a polyether polyurethane foam.

41. The structure of claim 37, wherein the polymeric material is a polyester polyurethane foam.

42. The structure of claim 1, wherein the at least one external surface of the flexible, electrically non-conductive, porous material is substantially entirely coated with the electrically conductive material.

43. The structure of claim 42, wherein the flexible, electrically non-conductive, porous material comprises a curved external side surface and two external end surfaces, the curved external side surface being individually contiguous with each of the two external end surfaces, and wherein the curved external side surface is the at least one external surface coated with the electrically conductive material.

44. The structure of claim 42, wherein the flexible, electrically non-conductive, porous material has a rectangular shape having four external side surfaces and two external end surfaces, wherein substantially the entirety of one of the external side surfaces and at least portions of the internal surfaces are coated with one or more layers of the electrically conductive material with the coated side external surface and the coated internal surfaces together forming an electrically conductive pathway.

45. The structure of claim 44, wherein substantially all of the internal surfaces of the flexible, electrically non-conductive, porous material are coated with the electrically conductive material.

46. The structure of claim 45, wherein an external side surface opposite to the external side surface coated with the electrically conductive material is also substantially entirely coated with one or more layers of the electrically conductive material, the two coated opposite external side surfaces and the coated internal surfaces together forming an electrically conductive pathway.

47. A device comprising the structure of claim 1 and a layer of catalyst for a fuel cell, said catalyst comprising at least one noble metal, wherein the at least one external surface of the flexible, electrically non-conductive, porous material coated with the electrically conductive material is in contact with the layer of catalyst.

48. A device comprising the structure of claim 43 and a layer of catalyst for a fuel cell, said catalyst comprising at least one noble metal, wherein the curved external side surface of the flexible, electrically non-conductive, porous material coated with the electrically conductive material is in contact with the layer of catalyst.

49. A device comprising the structure of claim 45 and a layer of catalyst for a fuel cell, said catalyst comprising at least one noble metal, wherein the external side surface of the flexible, electrically non-conductive, porous material coated with the electrically conductive material is in contact with the layer of catalyst.

50. A fuel cell comprising the following layers in serial contact:
(i) a first separator or bipolar plate;
(ii) a first gas diffusion layer, wherein the first gas diffusion layer is the structure of claim 1 further having at least a portion of the internal surfaces of the flexible, electrically non-conductive, porous material coated with one or more layers of the electrically conductive material;
(iii) an anode, comprising a layer of particulate catalyst for a fuel cell, wherein the catalyst is a noble metal or mixture of noble metals;
(iv) a solid polymer electrolyte or proton exchange membrane (PEM);
(v) a cathode, comprising a layer of particulate catalyst for a fuel cell, wherein the catalyst is a noble metal or mixture of noble metals;
(vi) a second gas diffusion layer, wherein the second gas diffusion layer is a structure of claim 1 further having at least a portion of the internal surfaces of the flexible, electrically non-conductive, porous material coated with one or more layers of the electrically conductive material; and
(vii) a second separator or bipolar plate,
wherein the at least one external surface of the flexible, electrically non-conductive, porous material of the first gas diffusion layer coated with the electrically conductive material is in contact with a surface of the anode opposite to an anode surface in contact with the PEM, with the coated at least one external surface and coated internal surfaces of the flexible, electrically non-conductive, porous material forming an electrically conductive pathway in contact with the anode and the first separator or bipolar plate; and
wherein the at least one external surface of the flexible, electrically non-conductive, porous material of the second gas diffusion layer coated with the electrically conductive material is in contact with a surface of the cathode opposite to a cathode surface in contact with the PEM, with the coated at least one external surface and coated internal surfaces of the flexible, electrically non-conductive, porous material forming an electrically conductive pathway in contact with the cathode and the second separator or bipolar plate.

51. A gas diffusion electrode for a fuel cell, which gas diffusion electrode comprises a catalyst on at least an external surface of a solid substrate, wherein the catalyst is a noble metal, or a mixture of noble metals, and wherein the solid substrate comprises a flexible, electrically non-conductive, porous material having a solid matrix, interconnected pores or interstices through the solid matrix, at least one external surface and internal surfaces, which internal surfaces are the surfaces of the walls of the pores or interstices, wherein at least a portion of the at least one external surface is coated with one or more layers of an electrically conductive material,
the electrically conductive material comprising a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1:m, with m being at least 500;
(b) at least population C of electrically conductive non-fibrous carbon particles and population D of electrically conductive carbon fibers, wherein the ratio of the D50% of population C and the average length of the fibers of population D is 1:n, with n being at least 2; and
(c) at least population E of electrically conductive carbon fibers and population F of electrically conductive carbon fibers, wherein the ratio of the average length of the fibers of population E and the average length of the fibers of population F is 1:p, with p being at least 2.

52. A bipolar plate for a fuel cell, which bipolar plate comprises a flexible, electrically non-conductive, non-permeable material having a solid matrix and at least one external surface, wherein at least a portion of the at least one external surface is coated with one or more layers of an electrically conductive material,
the electrically conductive material comprising a mixture of at least two populations of electrically conductive carbon particles, wherein the at least two populations of electrically conductive carbon particles are substantially uniformly mixed in the direction of a plane extending along the at least one external surface, and wherein the at least two populations are selected from the group consisting of
(a) at least population A of electrically conductive non-fibrous carbon particles and population B of electrically conductive non-fibrous carbon particles, wherein the ratio of the D50% of population A and the D50% of population B is 1:m, with m being at least 500;
(b) at least population C of electrically conductive non-fibrous carbon particles and population D of electrically conductive carbon fibers, wherein the ratio of the D50% of population C and the average length of the fibers of population D is 1:n, with n being at least 2; and
(c) at least population E of electrically conductive carbon fibers and population F of electrically conductive carbon fibers, wherein the ratio of the average length of the fibers of population E and the average length of the fibers of population F is 1:p, with p being at least 2.
